(19) United States
(12) Patent Application Publication
(10) Pub. No.: US 2026/0061669 A1
(43) Pub. Date: Mar. 5, 2026

(54) MOLDING STRIP AND IMPROVED FORMATION

(71) Applicants: Nicolas SURGET, LE CELLIER (FR); Pierre-Yves LINOT, LE CELLIER (FR)

(72) Inventors: Nicolas SURGET, LE CELLIER (FR); Pierre-Yves LINOT, LE CELLIER (FR)

(21) Appl. No.: 19/326,929

(22) Filed: Sep. 12, 2025

Related U.S. Application Data
(63) Continuation of application No. 17/783,761, filed on Jun. 9, 2022.

(30) Foreign Application Priority Data
Dec. 11, 2019 (FR) 1914162
Dec. 11, 2019 (FR) 1914165

(51) Int. Cl. B29C 41/38; A44B 18/00; B29C 41/28; B29C 43/22; B29C 43/46; B29C 43/48; B29L 31/00

(52) U.S. Cl. CPC B29C 41/38; A44B 18/0049; A44B 18/0065; A44B 18/0069; B29C 41/28; B29C 43/222; B29C 43/46; B29C 43/48; B29C 2043/486; B29L 2031/729; B29L 2031/738

(57) ABSTRACT

A molding device including a molding strip formed of a first material and extending along a machine direction, having a width defined along a transverse direction perpendicular to the machine direction, and a thickness measured along a direction perpendicular to the machine direction and to the transverse direction, and an inner face and an outer face, the molding strip including a plurality of cavities, characterized in that part of the cavities are at least partially obturated by a plugging material, so as to define molding cavities for forming retaining elements and/or preforms of retaining elements, and non-functional cavities.

### CROSS REFERENCE TO RELATED APPLICATION

This application is a continuation of U.S. Patent Application Serial No. Ser. No. 17/783,761, filed on Jun. 9, 2022, which is hereby incorporated by reference in its entirety.

### TECHNICAL FIELD

The present disclosure relates to molding devices for the production of self-gripping type retaining elements including retaining means such as hooks.

### BACKGROUND

Several systems and methods are known for the production of retaining elements provided with retaining means such as hooks, for example as described in documents WO2017187096, WO2017187097, WO2017187098, WO2017187099, WO2017187101, WO2017187102, WO2017187103 and WO2019145646.

A recurring issue relates to the production of strips including areas with retaining elements and areas devoid of retaining elements, which is technically complex and expensive. Moreover, it is currently difficult to make a clear delimitation between the areas having retaining elements and the adjacent areas devoid of retaining elements.

### SUMMARY

The present disclosure thus aims to address at least partially the issues mentioned above.

The present disclosure thus relates to a molding device for forming a retaining device including a base provided with a plurality of retaining elements and/or preforms of retaining elements,
the molding device including a molding strip formed of a first material and adapted to be mounted on a support, the molding strip extending along a machine direction, having a width defined along a transverse direction perpendicular to the machine direction, and a thickness measured along a direction perpendicular to the machine direction and to the transverse direction, the molding strip having an inner face and an outer face, the molding strip including a plurality of cavities, characterized in that part of the cavities is at least partially obturated with a plugging material, so as to define molding cavities for forming retaining elements and/or preforms of retaining elements, and non-functional cavities.

According to one example, the plugging material is distinct from the first material.

According to one example, the plugging material and/or the first material and/or the molding material are distinct.

According to one example, the plugging material is formed of a single layer. According to another example, the plugging material is formed of several layers, for example between 2 and 20 layers.

According to one example, the plugging material extends at least partly into the cavities of the molding strip. According to one example, the plugging material is fixed to the molding strip, particularly to at least one wall of a cavity of the molding strip.

According to one example, the plugging material extends at least partly between the inner face and the outer face of the molding strip.

According to one example, the plugging material is a resin.

According to one example, the plugging material being at least partly arranged in a cavity, the plugging material arranged between the inner face and the outer face of the molding strip, has a shape complementary to at least part of an internal volume of the cavity.

According to one example, the plugging material being at least partly arranged in a cavity, in a sectional view along a plane perpendicular to the machine direction and/or in a sectional view along a plane perpendicular to the transverse direction, the height of the plugging material arranged between the inner face and the outer face of the molding strip is greater than the sum of the heights of the plugging material outside the inner and outer faces of the molding strip.

According to one example, the plugging material is fixed to the molding strip, for example so as to form a one-piece element formed by the molding strip and the plugging material. According to one example, the molding strip and the plugging material are chemically and/or mechanically fixed together.

According to one example, the retaining elements each include a rod and a head, the head being formed by two wings which are opposite and which extend on either side of the rod along the same direction, or the head extends all around the rod over 360°.

According to one example, the plugging material extends on the inner face and/or on the outer face of the molding strip.

According to one example, the plugging material includes a polymer and/or a metal compound and/or an alloy and/or a composite, the composite including reinforcing elements such as particles and/or fibers and/or filaments and the plugging material being different from the material of the molding strip.

According to one example, the plugging material includes a polymer, particularly a thermoplastic and/or thermosetting polymer and/or an elastomer, for example a resin, more particularly a crosslinked resin, in particular ultraviolet and/or thermally and/or chemically and/or physically and/or radically crosslinked.

According to one example, the plugging material is sufficiently stable to maintain its integrity during the use of the molding strip, namely between temperatures included between 10° and 300° C.

According to one example, the plugging material includes at least one of the compounds among the following list: resin and/or sealant, more particularly:
an epoxy-based and/or acrylic and/or polyester and/or polyurethane and/or silicone resin,
an epoxy-based and/or acrylic and/or polyester and/or polyurethane and/or silicone sealant.

According to one example, part of the set of the cavities is at least partially obturated by the plugging material, so as to present at least two disjoint areas filled with plugging material in each of the cavities.

According to one example, part of the cavities is at least partially obturated by the plugging material, so as to present in each of the cavities, an area with the plugging material and an area devoid of plugging material. The cavities being through-cavities, the area devoid of plugging material is typically a through-area. The plugging material then allows reducing the section of the through-cavities.

According to one example, the molding cavities are arranged so as to form a pattern on the molding strip, typically a regular pattern. By “regular” it is meant that the pattern is repeated in the machine direction. Alternatively, the molding cavities are arranged so as to form several different patterns on the molding strip, typically regular patterns, for example patterns which are repeated alternately or not on the molding strip and in the machine direction.

According to one example, the molding strip, for example in a pattern area, includes a number of cavities/cm along the machine direction and/or along the transverse direction greater than 2 cavities/cm, more specifically greater than 5 cavities/cm, particularly greater than 10 cavities/cm, and less than 1,500 cavities/cm, more specifically less than 1,000 cavities/cm and for example less than 700 cavities/cm, more particularly less than 400 cavities/cm, even more particularly less at 200 cavities/cm.

According to one example, the molding strip, for example in a pattern area, includes an open rate included between 2% and 45%, particularly included between 3% and 30%, more particularly between 4% and 20%. Thus, the number of retaining elements to be demolded is limited to allow easier demolding and/or a lower demolding force. The molding strip includes in an area, in a view perpendicular to the molding strip, an elementary repeating surface including at least one molding cavity portion. The open rate of the molding strip is calculated by the ratio of: (the surface of the molding cavity in the elementary repeating surface)/(the elementary repeating surface). To avoid parallax errors, the open rate is preferably measured on a small area of the molding strip.

According to one example, the molding cavities are arranged so as to form one or several disjoint patterns. According to one example, the molding cavities are arranged so as to form a pattern which is repeated on the molding strip, for example between 4 and 600 repetitions of the pattern, or for example between 20 and 200 repetitions of the pattern.

According to one example, the molding strip has a thickness included between 50 and 500 microns, preferably between 70 and 350 microns, in some cases included between 100 microns and 250 microns.

According to one example, among the cavities, between 10% and 90% of the total number of cavities of the molding strip are at least partially obturated by the plugging material, preferably between 20% and 80%.

According to one example, the molding strip has a perimeter included between 200 mm and 3,000 mm, particularly between 400 mm and 2,000 mm.

According to one example, the molding strip has a density of cavities included between 50 and 3,000 per cm², particularly between 100 and 800 cm².

According to one example, the molding strip has borders extending along its ends along the machine direction, and the cavities located at a distance, along the transverse direction included between 2 and 5 mm, in some cases between 1 and 5 mm, in other cases included between 2 and 7 mm or between 1 and 10 mm, from the borders of the molding strip extending along the machine direction, are obturated.

According to one example, each pattern has at least one row and/or at least one column including at least two groups of disjoint molding cavities separated by an area of plugged cavities.

The present disclosure also relates to a method for preparing such a molding device, in which
a molding strip formed in a first material and adapted to be mounted on a support is provided, the molding strip extending along a machine direction, having a width defined along a transverse direction perpendicular to the machine direction, and a thickness along a direction perpendicular to the machine direction and to the transverse direction, the molding strip having an inner face and an outer face,
a plugging material is applied on the molding strip so as to obturate part of the cavities of the molding strip.

According to one example, during the step of applying a plugging material, all the cavities of the molding strip are obturated, then a step of removing (or eliminating) the plugging material from part of the cavities to define molding cavities is carried out.

The present disclosure also relates to a retaining device including a base having an upper face and a lower face, the base extending along a primary direction, having a width defined along a secondary direction perpendicular to the primary direction, and a thickness measured along a direction perpendicular to the primary direction and to the secondary direction, a plurality of retaining elements extending on the upper face of the base, each retaining element including a rod, the retaining elements being integrally formed, for example in one piece and resulting from extrusion, with the base, the retaining elements being arranged in rows and in columns extending respectively along the secondary direction and the primary direction, the device being characterized in that at least X rows and/or X columns of the retaining device have distinct numbers of retaining elements, where X is equal to 2. Particularly, X is equal to 3 or 4 or 5 or 6 to allow producing a complex pattern with a level of sufficiently accurate details. More generally, X is typically a natural number included between Xmin and Xmax, where Xmin can be for example equal to 2 or 3 or 4 or 5 or 6 or 7 or 8 or 9 or 10 or 12 or 15 or 20, and Xmax can for example be equal to 500 or 450 or 400 or 350 or 300 or 250 or 200 or 150 or 100 or 50. Such a device allows in particular defining patterns that have an appearance with optimized and improved accuracy compared to those of the prior art while maintaining a significant/satisfactory gripping capacity, even equivalent to an outer contour having a similar shape and without an area devoid of retaining elements.

According to one example, at least two rows and/or at least two columns of the retaining device have a distinct number of retaining elements, the difference between the numbers of retaining elements of the at least two rows and/or at least two columns being greater than or equal to 1, or more specifically, greater than or equal to 2, or for example greater than or equal to 3 or 4 or 5 or 6 to allow producing a complex pattern with a level of sufficiently accurate details.

According to one example, the plurality of retaining elements forms one or several disjoint patterns, each pattern being formed of a plurality of rows and columns of retaining elements. By “disjoint” it is meant that the patterns are separated by at least one row and/or one column devoid of retaining elements.

According to one example, the retaining elements are arranged so as to form a regular pattern on the upper face of the base. By “regular” it is meant that the pattern is repeated in the primary direction. In one variant, the retaining elements are arranged so as to form several different patterns on the upper face of the base, typically regular patterns, for example, patterns that are repeated, alternately or not, on the upper face of the base and in the primary direction.

According to one example, the retaining elements are arranged so as to form a pattern on the upper face of the base, typically a regular pattern. By “regular” it is meant that the pattern is repeated in the primary direction. Alternatively, the retaining elements are arranged so as to form several different patterns on the upper face of the base, typically regular patterns, for example, patterns that are repeated, alternately or not, on the upper face of the base and in the primary direction.

According to one example, the upper face of the base, for example in a pattern area, includes a number of retaining elements/cm along the primary direction and/or along the secondary direction greater than 2 retaining elements/cm, more specifically greater than 5 retaining elements/cm, particularly greater than 10 retaining elements/cm, and less than 1,500 retaining elements/cm, more specifically less than 1,000 retaining elements/cm and for example less than 700 retaining elements/cm, more particularly less than 400 retaining elements/cm, even more particularly less than 200 retaining elements/cm.

According to one example, for each pattern, each pair of rows arranged successively along the primary direction has a number of retaining elements whose variation is less than or equal to 10 retaining elements, particularly less than or equal to 5 retaining elements, which allows for example facilitating the demolding.

According to one example, for each pattern, each pair of rows arranged successively along the primary direction has a number of retaining elements, and optionally only those having a number of retaining elements greater than or equal to 7 retaining elements, in particular 8 retaining elements, for example 9 retaining elements, whose variation is less than or equal to 40% of the maximum number of retaining elements of the rows of the pair of rows of retaining elements, typically less than or equal to 30% or 15%.

According to one example, for each pattern, each pair of columns arranged successively along the secondary direction has a number of retaining elements whose variation is less than or equal to 15 retaining elements, or less than or equal to 10 retaining elements, particularly less than or equal to 5 retaining elements.

According to one example, for each pattern, each pair of columns arranged successively along the secondary direction has a number of retaining elements and optionally only those having a number of retaining elements greater than or equal to 7 retaining elements, in particular 8 retaining elements, for example 9 retaining elements, whose variation is less than or equal to 40% of the maximum number of retaining elements of the columns of the pair of columns of retaining elements, typically less than or equal to 30% or 15%.

According to one example, each pattern is entirely surrounded by a region of the upper face of the base devoid of retaining elements, and is located at a distance greater than 1.5 mm, particularly, 2.5 mm from a border of the base, particularly from all the borders of the base.

According to one example, each pattern is delimited by an outer contour, and each pattern includes, in the area delimited by its outer contour, at least one area devoid of retaining elements. According to one example, the outer contour can be bordered on the base by a (continuous or discontinuous) slot or a (continuous or discontinuous) stud and respectively on the molding strip by a (continuous or discontinuous) stud or a (continuous or discontinuous) slot.

According to one example, the (or each) pattern being delimited by an outer contour, and the (or each) pattern including, in the area delimited by its outer contour, at least one area devoid of retaining elements, the (preferably each) retaining elements arranged in close proximity to the outer and/or inner contour (and/or defining it/them) have a rod shape similar or identical to those of the retaining elements at a distance from the outer and/or inner contour. According to one example, the (or each) pattern being delimited by an outer contour, and the (or each) pattern including, in the area delimited by its outer contour, at least one area devoid of retaining elements, the (preferably each) retaining elements arranged in close proximity to the outer and/or inner contour (and/or defining it/them) have a head shape similar or identical to those of the retaining elements at a distance from the outer and/or inner contour. By “close proximity” it is meant the retaining elements located in the rows and/or columns adjacent or spaced by a maximum of 2 rows and/or columns from the rows and/or columns defining the considered outer or inner contour. In contrast, it is considered that the retaining elements, being separated from the inner or outer contour considered by at least two rows and/or columns, are at a distance from the considered contour, or more generally that the retaining elements which are not in close proximity to the considered contour are at a distance from the considered contour. Thus, the retaining device has a maximized grip, particularly in close proximity to the outer and/or inner contours while having a more accurate representation of the pattern. The retaining elements in close proximity to the outer and/or inner contour (and/or defining it/them) thus have an optimized gripping capacity without hindering the cooperation with the counterpart.

According to one example, the (or each) pattern being delimited by an outer contour, and the (or each) pattern including, in the area delimited by its outer contour, at least one area devoid of retaining elements (or where appropriate of cavities), the inner contour has at least one local portion of elongated shape defining a local center line arranged at a distance from the local inner contour less than 20%, particularly less than 15%, of the dimension of the pattern along the primary direction and/or the secondary direction. Alternatively or additionally, the (or each) pattern being delimited by an outer contour, and the (or each) pattern including, in the area delimited by its outer contour, at least one area devoid of retaining elements, the inner contour has at least one local portion of elongated shape defining a local center line arranged at a distance from the local inner contour less than 10 mm, or less than 5 mm, particularly less than 3 mm, more particularly less than 2 mm, even more particularly less than 1 mm and greater (or strictly greater) than an average pitch of the retaining elements in the considered pattern. A circular area devoid of retaining elements does not form a median within the meaning of the present document. Thus, the retaining device has a maximized grip while allowing a more detailed and accurate representation of the pattern. The local center line includes straight and/or curved portions. The length of the center line of the at least one inner contour is typically greater than 10 mm, or for example greater than 12 mm. The sum of the lengths of the center lines of the inner contours of a pattern is typically greater than 12 mm, for example greater than 15 mm and/or typically less than 600 mm, for example less than 400 mm, more particularly less than 200 mm. Such a configuration can also be transposed to the cavities formed in the molding strip described in the following text.

According to one example, each pattern has at least one row and/or at least one column including at least two groups of disjoint retaining elements separated by an area devoid of retaining elements. According to one example, the retaining elements each include a rod and a head, the head being formed by two wings which are opposite and which extend along the same direction or the head extends all around the rod over 360°.

According to one example, for each pattern, at least one, preferably each, area devoid of retaining elements included in the pattern has a width and a length, so that the ratio between the length and the width is strictly greater than 1.1, particularly strictly greater than 1.2 more particularly strictly greater than 1.5.

According to one example, for each pattern, at least one, preferably each, area devoid of retaining elements included in the pattern has a maximum dimension and a minimum dimension, so that the ratio between the maximum dimension and the minimum dimension is strictly greater than 1.1, particularly strictly greater than 1.2, more particularly strictly greater than 1.4 and even more particularly greater strictly than 1.6.

According to one example, the rows and columns are evenly spaced according to a secondary interval and a primary interval respectively. According to another example, the rows are evenly spaced according to a first secondary interval and according to a second secondary interval, the second secondary interval not being an integer multiple of the first secondary interval and the first secondary interval being smaller than the second secondary interval, and/or the columns are evenly spaced according to a first primary interval and according to a second primary interval, the second primary interval not being an integer multiple of the first primary interval and the first primary interval being smaller than the second primary interval.

According to one example, each pattern is entirely surrounded by a region of the upper face of the base devoid of retaining elements, the region having a dimension strictly greater than twice the primary interval along the primary direction, and/or strictly greater than twice the secondary interval along the secondary direction.

According to one example, the at least one area devoid of retaining elements included in the area delimited by the outer contour of each pattern has a dimension along the primary direction strictly greater than twice the primary interval, and a dimension along the secondary direction strictly greater than twice the secondary interval.

According to one example, for each pattern, the ratio between the surface of the areas devoid of retaining elements contained in the outer contour of the pattern and the surface including retaining elements is less than 1. According to one example, the at least one pattern, is symmetrical. According to another example, the pattern is delimited by one or several (inner and/or outer) borders, the sum of the lengths of the inner and outer borders is greater than 70 mm, preferably greater than 95 mm, preferably greater than 100 mm, more particularly greater than 150 mm and in some cases less than 5,000 mm, more particularly less than 3,000 mm. Thus, the longer the outer and inner borders, the smaller the fakir mat effect. The fakir mat effect is an effect in the field of hook-and-loop type fasteners which, due to the excessive number of hooks relative to the number of loops, makes it difficult, even impossible, for the hooks to penetrate the loops in order to form a hook-and-loop fastener. The retaining element device therefore has a greater ability to cooperate with gripping loops. According to one example, the pattern is inscribed in a four-sided polygon, each side of which is flush with a portion of the outer perimeter of the pattern and the polygon including a perimeter P1. The ratio (Pint+Pext)/P1 is greater than 1, in some cases greater than 1.2 or 1.3 or 1.4 or 1.5 or 1.6 and in some cases less than 20, particularly less than 15. Thus, the longer the outer and inner borders, the smaller the fakir mat effect. The retaining element device therefore has a greater ability to cooperate with gripping loops.

The present disclosure also relates to a molding device for forming a retaining device, for example as defined previously, the molding device including a molding strip adapted to be mounted on a support, the molding strip extending along a machine direction, having a width defined along a transverse direction perpendicular to the machine direction, and a thickness measured along a direction perpendicular to the machine direction and to the transverse direction, the molding strip having opposite inner face and outer face, the molding strip having a plurality of cavities arranged in rows and columns extending respectively along the transverse direction and the machine direction, the cavities opening out onto the outer face of the molding strip, characterized in that at least Y rows and/or Y columns of cavities of the molding strip have distinct numbers of cavities, where Y is equal to 2. Particularly, Y is equal to 3 or 4 or 5 or 6 to allow producing a complex pattern with a level of sufficiently accurate details. More generally, Y is typically a natural number included between Ymin and Ymax, where Ymin can be for example equal to 2 or 3 or 4 or 5 or 6 or 7 or 8 or 9 or 10 or 12 or 15 or 20, and Ymax can for example be equal to 500 or 450 or 400 or 350 or 300 or 250 or 200 or 150 or 100 or 50.

A row of cavities typically includes between 1 and 1,000 cavities. A column of cavities typically includes between 1 and 1,000 cavities.

According to one example, at least two rows and/or at least two columns of the molding device have a distinct number of cavities, the difference between the numbers of cavities of the at least two rows and/or at least two columns being greater than or equal to 1, or more specifically greater than or equal to 2, or for example greater than or equal to 3 or 4 or 5 or 6 to allow producing a complex pattern with a level of sufficiently accurate details.

According to one example, the plurality of cavities forms one or several disjoint patterns, each pattern being formed of a plurality of rows and columns of cavities. By “disjoint” it is meant that the cavities are separated by at least one row and/or one column devoid of cavities. According to one example, the cavities are arranged so as to form a regular pattern on the molding strip. By “regular” it is meant that the pattern is repeated in the machine direction. Alternatively, the cavities are arranged so as to form several different patterns on the molding strip, typically regular patterns, for example patterns which are repeated, alternately or not, on the molding strip and in the machine direction.

According to one example, for each pattern, each pair of rows arranged successively along the machine direction has a number of cavities whose variation is less than or equal to 10 cavities, or more specifically less than or equal to 5 cavities, which allows for example facilitating the demolding.

According to one example, for each pattern, each pair of rows arranged successively along the machine direction has a number of cavities, and optionally only those having a number of cavities greater than or equal to 7 cavities, in particular 8 cavities, for example 9 cavities, whose variation is less than or equal to 40% of the maximum number of cavities of the rows of the pair of rows of cavities, typically less than or equal to 30% or 15%.

According to one example, for each pattern, each pair of columns arranged successively along the transverse direction has a number of cavities whose variation is less than or equal to 15 cavities, or less than or equal to 10 cavities or more specifically less than or equal to 5 cavities.

According to one example, for each pattern, each pair of columns arranged successively along the transverse direction has a number of cavities and optionally only those having a number of cavities greater than or equal to 7 cavities, in particular 8 cavities, for example 9 cavities, whose variation is less than or equal to 40% of the maximum number of cavities of the rows of the pair of rows of cavities, typically less than or equal to 30% or 15%.

According to one example, each pattern is entirely surrounded by a region of the outer face of the molding strip devoid of retaining elements, and is located at a distance greater than 1.5 mm, particularly greater than 2.5 mm from a border of the molding strip, particularly from all the borders of the molding strip.

According to one example, each pattern is delimited by an outer contour, and each pattern includes, in the area delimited by its outer contour, at least one area devoid of cavities.

According to one example, each pattern has at least one row and/or at least one column including at least two disjoint groups of cavities separated by an area devoid of cavities.

According to one example, for at least one pattern, at least one, or for example each, area devoid of cavities included in the pattern has a width and a length so that the ratio between the length and the width is strictly greater than 1.2, particularly strictly greater than 1.5.

According to one example, for each pattern, at least one, or for example each, area devoid of cavities included in the pattern has a width and a length so that the ratio between the length and the width is strictly greater than 1.2, particularly strictly greater than 1.5.

According to one example, the cavities of the molding device are through-cavities.

According to one example, the columns and rows are evenly spaced according to a transverse interval and a machine interval respectively. According to another example, the rows are evenly spaced according to a first transverse interval and according to a second transverse interval, the second transverse interval not being an integer multiple of the first transverse interval and the first transverse interval being smaller than the second transverse interval, and/or the columns are evenly spaced according to a first machine interval and according to a second machine interval, the second machine interval not being an integer multiple of the first machine interval and the first machine interval being smaller than the second machine interval.

According to one example, each pattern is entirely surrounded by a region of the outer face of the molding strip devoid of cavities, the region having a dimension strictly greater than twice the machine interval along the machine direction, and strictly greater than twice the transverse interval along the transverse direction.

According to one example, the at least one area devoid of cavities included in the area delimited by the outer contour of each pattern has a dimension along the machine direction strictly greater than twice the machine interval, and a dimension along the transverse direction strictly greater than twice the transverse interval.

According to one example, for each pattern, the ratio between the surface of the areas devoid of cavities contained in the outer contour and the surface including cavities is less than 1. According to one example, the at least one pattern is symmetrical. According to another example, the pattern is delimited by one or several (inner and/or outer) borders, the sum of the lengths of the inner and outer borders is greater than 70 mm, preferably greater than 95 mm, preferably greater than 100 mm, more particularly greater than 150 mm and in some cases less than 5,000 mm, more particularly less than 3,000 mm. Thus, the longer the outer and inner borders, the smaller the “fakir mat” effect. The retaining element device obtained thanks to such a molding device therefore has a greater ability to cooperate with gripping loops. According to one example, the pattern is inscribed in a four-sided polygon, each side of which is flush with a portion of the outer perimeter of the pattern and the polygon including a perimeter P1. The ratio (Pint+Pext)/P1 is greater than 1, in some cases greater than 1.2 or 1.3 or 1.4 or 1.5 or 1.6 and in some cases less than 20, particularly less than 15. Thus, the longer the outer and inner borders, the smaller the “fakir mat”effect. The retaining element device obtained thanks to such a molding device therefore has a greater ability to cooperate with gripping loops.

The present disclosure further relates to a retaining device including a base, typically continuous base, having an upper face and a lower face, the base extending along a primary direction, having a width defined along a secondary direction perpendicular to the primary direction, and a thickness measured along a direction perpendicular to the primary direction and to the secondary direction, a plurality of retaining elements extending over the upper face of the base, each retaining element including a rod, the retaining elements being integrally formed with the base, the retaining elements being arranged in rows and columns extending respectively along the secondary direction and the primary direction, the rows and columns being typically evenly spaced according to a primary interval and a secondary interval respectively, the plurality of retaining elements forming one or several disjoint patterns, each pattern being formed of a plurality of rows and columns of retaining elements, the device being characterized in that the retaining elements each have a rod extending from the upper face of the base, and a head surmounting the rod, and for a pattern, typically for each pattern, the heads of the retaining elements forming a first end of the pattern along a first direction have a first maximum dimension along a second direction, and the heads of the retaining elements forming a second end of the pattern along the first direction, opposite to the first end of the pattern along the first direction, have a second maximum dimension along the second direction, the second maximum dimension being strictly smaller than the first maximum dimension.

According to one example, for a pattern, the maximum dimension of the heads of the retaining elements decreases from the first end of the pattern towards the second end of the pattern along the second direction.

According to one example, the retaining elements forming the first end and the retaining elements forming a second end are arranged on the same column or row. The first direction typically corresponds to the primary direction or to the machine direction; the direction from the first end to the second end typically corresponds to the running direction of the tape along the machine direction during its production.

### BRIEF DESCRIPTION OF THE DRAWINGS

The disclosure and its advantages will be better understood upon reading the detailed description given below of different embodiments of the disclosure given by way of non-limiting examples.

FIG. 1 is a schematic view of a retaining device according to one aspect of the disclosure.

FIG. 2 is a sectional view of FIG. 1.

FIG. 3 is a representation of a molding device.

FIG. 4 is a representation of one variant of a molding device.

FIG. 5 is a detailed view of FIG. 4.

FIG. 6 is a representation of a retaining device.

FIG. 7 is a detail view of FIG. 6.

FIG. 8 schematically represents a pattern of retaining elements or cavities.

FIG. 9 schematically represents another pattern of retaining elements or cavities.

FIG. 10 schematically represents another pattern of retaining elements or cavities.

FIG. 11 schematically represents another pattern of retaining elements or cavities.

FIG. 12 schematically represents another pattern of retaining elements or cavities.

FIG. 13 schematically represents another pattern of retaining elements or cavities.

In all the figures, the elements in common are identified by identical numerical references.

### DESCRIPTION OF THE EMBODIMENTS

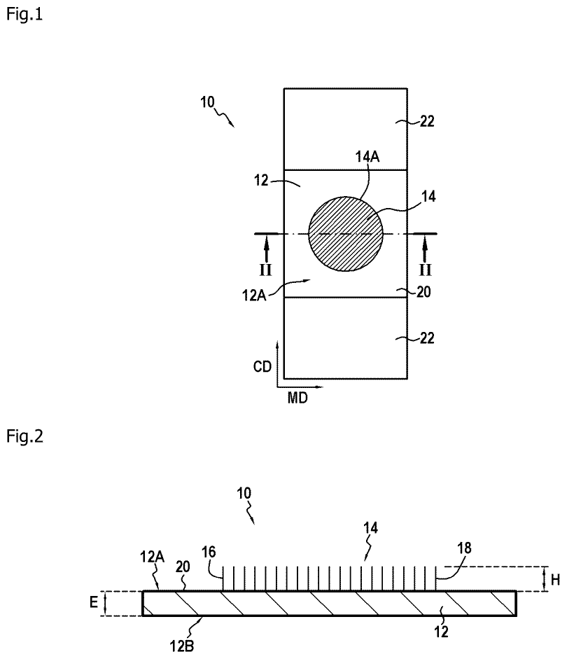

FIG. 1 schematically represents a retaining device 10 including a base 12, which is typically continuous, and a pattern 14 in the form of a solid disc. As represented in FIG. 2, the base 12 includes an upper face 12A and a lower face 12B and the pattern 14 is formed by a plurality of retaining elements 16 extending from the upper face 12A of the base 12. By “continuous base” it is meant that the base is devoid of through-openings or recesses in the areas without retaining elements. The base 12 typically has a constant width.

Each retaining element 16 includes a rod 18. The base 12, particularly the upper face 12A of the base 12, also includes areas 20 devoid of retaining elements 16. For reasons of simplification, the retaining elements 16 are represented with hatched lines in FIG. 1. In the embodiment of FIG. 1, the retaining device 10 includes a strip 22 of nonwoven (or woven) material. For example, the base 12 can be overmolded on the strip 22 of nonwoven material. The base 12 can also be bonded on the strip 22 of nonwoven material. The pattern 14 may be a single pattern (as represented in FIG. 1) or a repeating pattern 14. The pattern 14 is typically delimited by a closed contour 14A.

The base 12 and the retaining elements 16 are typically made of a thermoplastic material, for example a non-elastic thermoplastic material. The base 12 and the retaining elements 16 are made such that they can be stretched under the effect of a stretching force exerted along a given direction and without substantially resuming their initial shape and dimensions after releasing this stretching force, in some cases the base breaks under the effect of a stretching force. This is for example a base and the retaining elements which retain a residual deformation or remanence after elongation and release (residual deformation also called “permanent set” or “SET”) greater than or equal to 20%, preferably greater than or equal to 30%, of its initial dimension (before elongation) for an extension of 100% of its initial dimension, at room temperature (23° C.—degree Celsius).

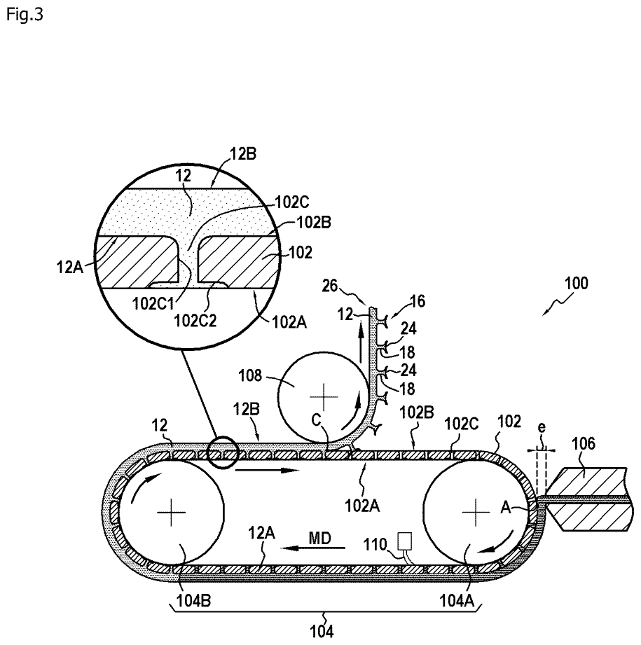

The retaining device 10 can be manufactured for example by means of an equipment 100 as represented in FIG. 3. The equipment 100 allows manufacturing a tape 26 for a retaining device, the tape 26 can then be cut or subdivided into a plurality of retaining devices 10. The tape 26 includes the base 12 which is here continuous, and a plurality of retaining elements 16. In the embodiment of FIG. 3, the retaining elements 16 are hooks, each hook including a rod 18 surmounted by a head 24.

The equipment 100 as represented includes a molding strip 102 positioned on rotational drive means 104 including here two rollers 104A, 104B, a material distribution means 106, for example an injector, suitable for making an injection of molding material, for example thermoplastic molding material.

The assembly formed by the molding strip 102 and the rotational drive means 104 thus forms a molding device.

By “machine direction MD” it is meant the direction of displacement of the molding strip 102 in the equipment 100 during the manufacture of the retaining device, in accordance with the acronym for “Machine Direction”, and by “transverse direction CD”, in accordance to the acronym for “Cross Direction”, the direction perpendicular to the machine direction MD. These directions are thus identified on the different figures.

The illustrated example including two rollers 104A, 104B is not limiting, the number and arrangement of the roller(s) may vary in particular in order to fit the length of the molding strip 102 and the different positions of the equipment. Three rollers or only one could for example be used so that the molding strip is arranged on the periphery of the single roller to form a sleeve or a screen. Particularly, only one of the two rollers can be driven in rotation by motorized means, for example the roller 104A, the other roller 104B being free, that is to say without motorized means, and driven in rotation via the molding strip, itself driven by the roller 104A.

The molding strip 102 as presented includes an inner face 102A and an outer face 102B, the inner face 102A being in contact with the rotational drive means 104.

The material distribution means 106 is disposed so as to inject molding material on the outer face 102B of the molding strip 102.

More specifically, the material distribution means 106 is disposed facing the molding strip 102, spaced from the molding strip 102 so as to define an air gap “e” indicated in FIG. 3. The reference A identifies the limit of the material injected on the outer face 102B of the molding strip 102, corresponding to the rear edge of the material injected on the molding strip 102 with respect to the direction of displacement of the molding strip 102.

The molding strip 102 is provided with a plurality of cavities 102C allowing the production of retaining elements or preforms for the production of retaining elements, for example by a subsequent calendering operation or any other suitable operation. Throughout the description, “retaining elements” will designate retaining elements or preforms for the production of retaining elements intended to form a self-gripping closing mechanism of the hook-and-hook or hook-and-loop type.

The cavities 102C are each typically formed so as to define a rod 102C1 extending from the outer face 102B towards the inner face 102A of the molding strip 102 and a head 102C2 extending between the rod 102C1 and the inner face 102A of molding strip 102.

The molding strip 102 typically has a thickness included between 50 and 500 microns, or typically between 70 and 350 microns.

The molding strip 102 is typically continuous, and typically has a perimeter included between 200 mm and 3,000 mm, or typically between 400 mm and 2,000 mm.

The molding strip 102 has a density of cavities 102C included between 50 and 3,000 cavities per cm², or typically between 100 and 800 cavities per cm².

It is thus understood that the arrangement of the cavities 102C determines the arrangement of the retaining elements on the retaining device formed using the equipment 100. The cavities 102C are typically disposed in rows and columns, the rows and columns being arranged respectively along the transverse direction CD and the machine direction MD. Each row and column is composed of one or several cavities 102C, if necessary aligned along the transverse direction CD and the machine direction MD respectively.

Within the same row, the successive cavities 102C are typically evenly spaced according to a transverse interval. Within the same column, the successive cavities 102C are typically evenly spaced according to a machine interval. Alternatively, the rows are evenly spaced according to a first transverse interval and according to a second transverse interval, the second transverse interval not being an integer multiple of the first transverse interval and the first transverse interval being smaller than the second transverse interval, and/or the columns are evenly spaced according to a first machine interval and according to a second machine interval, the second machine interval not being an integral multiple of the first machine interval and the first machine interval being smaller than the second machine interval.

The rows and columns of cavities 102C can be aligned or disposed in a staggered manner. More specifically, the different cavities 102C can be disposed so as to be aligned along the transverse direction CD and along the machine direction MD, or be offset so as to form a staggered or honeycomb pattern, two successive rows or two successive columns being then offset respectively along the transverse direction and along the machine direction, by a pitch corresponding to half the transverse interval or to half the machine interval respectively.

As will be seen later, the result is that the retaining elements 16 formed using these cavities 102C are disposed in a column and row arrangement, respectively along a primary direction and a secondary direction, typically corresponding to the machine direction MD and to the transverse direction CD.

In the example illustrated, the heads 24 of the cavities 102C open out onto the inner face 102A of the molding strip 102. The cavities 102C are therefore through-cavities. Such an embodiment is not limiting, the cavities 102C may also be blind, and therefore not open out from the inner face 102A of the molding strip 102 and/or the cavities 102C may only include a rod 102C1.

The portions of the cavities 102C forming the rods 102C1 typically extend along a direction perpendicular to the outer face 102B of the molding strip 102. The portions of the cavities 102C forming the rods 102C1 typically have a geometry of rotation about an axis perpendicular to the outer face 102B of the molding strip 102, or a geometry having a plane of symmetry extending along a direction parallel to the running direction of the molding strip 102 and/or along a direction perpendicular to the running direction of molding strip 102.

The portions of the cavities 102C forming the heads 102C2 typically extend radially or transversely with respect to an axis perpendicular to the outer face 102B of the molding strip 102, and may have rotational symmetry about this axis perpendicular to the outer face 102B of the molding strip 102. The portions of the cavities 102C forming the heads 102C2 typically have a substantially frustoconical or hexahedral shape.

The portions of the cavities 102C forming the heads 102C2 can be linear or curved, for example to form curved portions towards the inner face 102A or towards the outer face 102B of the molding strip 102 extending from the portions of the cavities 102C forming the rods 102C1. The molding strip may further have a shape such as the shapes described in patent applications WO0213647 A2 and/or WO0050208 A2.

The portions of the cavities 102C forming the heads 102C2 can have a constant or variable thickness.

In the example represented in the figures, the portions of the cavities 102C forming the heads 102C2 extend radially around the portions of the cavities 102C forming the rods 102C1, and have the general shape of a disk.

The molding strip 102 can have on its inner face 102A or on its outer face 102B a particular texturing such as slots, a groove network or a passage network forming vents or pins, or be substantially smooth.

The molding strip 102 can be formed by a superimposition of several strips, and is therefore not necessarily a single-piece or a single-material. The molding strip 102 can be composed of one or several typically metal materials or composites of the Ni, Cu, stainless steel type, or any other suitable material.

The material distribution means 106 is typically disposed so as to carry out the injection of molding material into the molding strip 102 in one section of the molding strip 102 where the latter bears against a drive roller, in this case the drive roller 104A in the example represented in FIG. 3. The drive roller then forms a bottom for the cavities 102C.

In the case where the injection of molding material is carried out while the molding strip 102 is not bearing against a drive roller, the material distribution means 106 can then include a pedestal disposed the other side of the molding strip 102, so that the inner face 102A of the molding strip 102 bears against the base when the injection of material is carried out, the pedestal then forming a bottom for the cavities 102C of molding strip 102.

The use of a molding strip 102 associated with drive means 104 compared to the use of conventional formation means such as rollers in which molding cavities are directly produced is advantageous for several reasons.

The use of a molding strip 102 is in particular interesting in terms of modularity. The molding strip can indeed be easily removed from the drive means and replaced, unlike a solid roller for which the dismounting and remounting operations are particularly complex to carry out. Such an advantage is particularly observed when the two rollers 104A, 104B are fixed to a frame on one and the same side, leaving the end of the other side free to introduce/remove the molding strip. A means for guiding the molding strip can also be used in order to facilitate its introduction and/or removal.

In addition, the production of a molding strip is greatly simplified compared to the production of a roller including molding cavities. Such rollers are indeed typically produced by stacking of successive slices, therefore requiring multiple machining operations and causing significant stresses during the assembly and at each change of reference of the hooks and has a significant mass requiring the holding of these rollers through their two ends, which therefore complicates their replacement.

The cavities 102C in the molding strip 102 can be produced by a chemical etching process or by use of a laser at the places where it is desired to form retaining elements 16. It is also possible to envisage producing the molding strip 102 with cavities 102C distributed uniformly over the entire molding strip 102 and then plugging the cavities 102C at the places where it is desired to form areas 20 devoid of retaining elements 16.

More specifically, in order to be able to define different configurations in the arrangement of the retaining elements and thus define a tape having retaining elements arranged so as to form patterns, the molding strip 102 has cavities 102C with a configuration similar to that of the retaining elements. The cavities 102C are formed directly by the molding strip 102, in the material forming the molding strip 102.

However, it is understood that the production of cavities 102C in the molding strip 102 is complex to achieve, more particularly in the case of a non-uniform distribution.

The cavities 102C can thus be produced uniformly on the molding strip 102, then part of the thus formed cavities can be at least partially obturated, while another part of the cavities is not obturated. Such total or partial obturation of part of the cavities 102C thus allows defining two subsets of the cavities: functional cavities, and non-functional cavities.

By “functional cavities” it is meant cavities that can thus be filled with molding material so as to form retaining elements or preforms of retaining elements.

By “non-functional cavities” it is meant cavities that have been totally or partially obturated, so that the molding material cannot penetrate them in order to form retaining elements or preforms of retaining elements. It is however understood that due to a possible removal of material, the non-functional cavities can cause irregularities during the formation of the retaining device, these irregularities having however a smaller dimension compared to the retaining elements or to the preforms formed by the functional cavities, typically one dimension along a direction perpendicular to the upper face 12A of the base 12 at least 5 times lower. In some cases, the cavities 102C of the molding strip 102, in at least one sectional view perpendicular to the inner face, in this view includes a dimension W1 at the inner face of the molding strip greater than a dimension W2 at the outer face of the molding strip in order to allow improving the peel values. In other cases, the cavities 102C of the molding strip 102, in at least one sectional view perpendicular to the inner face, in this view includes a dimension W1 at the inner face of the molding strip smaller than a dimension W2 at the outer face of the molding strip in order to improve the demolding. The ratio between W1/W2 is for example included between 0.7 and 1.2, particularly between 0.8 and 1.2 to have a good compromise between peel force and ease of demolding.

The material used to achieve such a total or partial obturation of part of the cavities 102C is a plugging material, typically distinct from the injection material (or molding material). The plugging material is for example a resin. The plugging material can be formed in one layer, or in several deposited layers, typically between 2 and 20 layers, for example deposited successively.

The plugging material may extend on the outer face and/or on the inner face of the molding strip. According to one example, part of the set of the cavities 102C is at least partially obturated by the plugging material, so as to present at least two disjoint areas filled with plugging material in each of the cavities. According to one example, part of the cavities 102C is at least partially obturated by the plugging material, so as to present in each of the cavities 102C, an area with the plugging material and an area devoid of plugging material. The cavities 102C being through-cavities, the area devoid of plugging material is typically a through-area. The plugging material then allows reducing the section of the through-cavities. The plugging material is then for example partially removed by laser ablation.

According to one example, between 10% and 90%, or between 20% and 80% of the total number of cavities 102C of the molding strip 102 are at least partially obturated.

According to one example, the cavities 102C located at a distance along the transverse direction CD less than or equal to 10 mm from the borders of the molding strip 102 extending along the machine direction MD are obturated.

In some cases, the cavities 102C located at a distance along the transverse direction CD included between 2 and 5 mm, in some cases between 1 and 5 mm, in other cases included between 2 and 7 mm or even between 1 mm and 10 mm, the borders of the molding strip 102 extending along the machine direction MD are obturated.

Alternatively, it is possible in a first step to obturate all of the cavities 102C of the molding strip, then in a second step to remove the plugging material from part of the cavities 102C.

Alternatively, the cavities 102C can be produced by drilling, in particular by laser drilling, in a molding strip 102 initially devoid of cavities 102C. Such a method thus allows producing the cavities 102C only at the desired locations.

Alternatively, the molding strip 102 can be formed by a differentiated growth process, for example by electroforming well known in the field of printing, by positioning resin depositions in a localized manner in order to prevent the growth of a metal material, for example nickel, in some areas which will thus define cavities. Alternatively, the molding strip 102 can be formed by a differentiated decay process, for example by an etching process.

The cavities 102C can have identical or distinct shapes.

As will be seen later, the cavities 102C can be arranged in different patterns.

The reference C in FIG. 3 identifies the separation between the tape 26 and the molding strip 102, this point corresponding for example to the level from which the base 12 of the tape 26 is no longer in contact with the molding strip 102. It can be provided that the molding strip 102 blocks the demolding roller 108, that is to say the demolding roller 108 forms a lever in the molding strip 102 to facilitate the demolding of the preforms and/or hooks.

In the represented example, the cavities 102C of the molding strip 102 are through-cavities. The equipment can then include an element, such as a scraper 110, positioned so as to scrape the inner face 102A of the molding strip 102 to remove the excess molding material if necessary. By “injection” it is meant the action of shaping a molding material by molten process, for example, the distribution, the supply, the molding, the injection, the extrusion.

The equipment presented above and the associated method can also have means for and a step of associating a strip 22 of nonwoven (or woven) material with the base 12.

Such an association of a strip 22 on a base 12 including retaining elements 16 is typically achieved by means of an adhesive, or via a melting of the base or of the strip and/or via mechanical anchoring.

In order to secure a strip 22, for example of nonwoven material, to the base 12 of the retaining device 10, the proposed equipment 100 can include strip 22 drive means, suitable for carrying out a strip supply and for applying the strip against the lower face 12B of the base 12 downstream of the material distribution means 106.

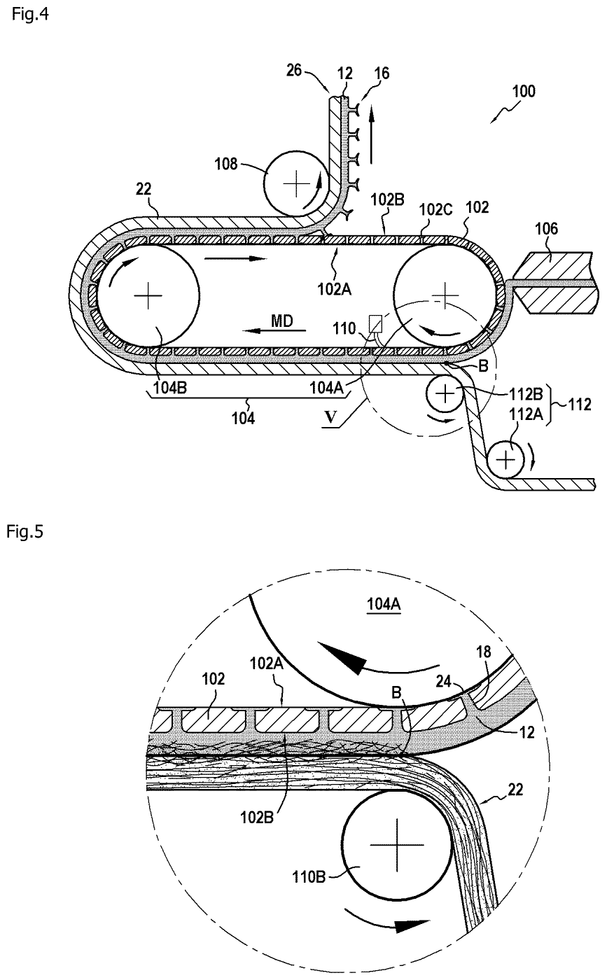

FIGS. 4 and 5 schematically represent one example of equipment 100 including such means.

The equipment as illustrated is similar to the equipment presented previously with reference to FIG. 3; the elements in common are therefore not described again here.

As seen in FIGS. 4 and 5, the equipment as presented includes strip drive means 112, here including of two rollers 112A, 112B, configured to carry out a strip 22 supply downstream of the material distribution means 106.

The strip 22 is typically a layer of non-woven material, a thermoplastic film, an elastic film or a composite film, or a thermally consolidated set of fibers and/or filaments. The strip 22 is for example a web of fibers and/or filaments.

In the example represented in FIGS. 4 and 5, the strip is represented as a layer of non-woven material.

The substrate drive means 110 are configured to supply the equipment with a strip 22 and apply this strip 22 against the lower face 12B of the base 12 downstream of the material distribution means 106.

The substrate drive means 110 are configured such that this application is carried out prior to the solidification of the base 12. Thus, this application causes an at least partial penetration of the strip 22 beyond a plane defined by the lower face 12B of the base 12. The reference B in the figures identifies the point of contact between the base 12 and the strip 22.

More specifically, the lower face 12B of the base 12 is substantially planar, and defines a plane. The application of the substrate against this face causes a penetration of portions of the strip 22, for example of fibers and/or filaments of the layer of nonwoven material in the case where the strip 22 is a layer of nonwoven material within the base 12, thereby passing through the lower face 12B of the base 12.

Insofar as such an application is carried out prior to the solidification of the base 12, it is not necessary to heat the base 12 and/or the strip 22 in order to achieve such a bond.

By way of example, considering a base 12 made of polypropylene, the application of the substrate against the lower face 12B of the base 12 is typically carried out when the lower face 12B of the base 12 has a temperature included between the melting temperature of the material and the softening temperature Vicat B of the material constituting it minus 30° C. (degrees Celsius) or between the melting temperature of the material constituting it and the softening temperature Vicat A of the material constituting it. More particularly, when the base includes a polypropylene-based material, the lower face 12B of the base 12 has a temperature included between 75° C. and 150° C., typically on the order of 105° C., this temperature being typically measured using an infrared or laser camera. By “softening temperature VICAT” it is meant the temperature obtained according to one of the methods described in the ISO 306 or ASTM D 1525 standards with a heating rate of 50° C./h and a normalized load of 50N for the VICAT B and a normalized load of 10N for the VICAT A.

The strip 22 can be applied uniformly or non-uniformly against the lower face 12B of the base 12.

The bond achieved between the strip 22 and the base 12 can be achieved uniformly or non-uniformly.

In the case where the strip 22 is a set of thermally consolidated fibers and/or filaments, the bond with the base 12 is also achieved by penetration into the base 12 of part of the fibers and/or filaments of the strip 22.

In the case where the strip 22 is a set for example of thermally consolidated fibers and/or filaments, a thermoplastic film, an elastic film or a composite film, a phenomenon of shrinkage of the base 12 during its cooling can then result from the bond with the base, this shrinkage favoring the bonding surface between the substrate and the base of the tape. This shrinkage has no impact on the visual appearance for the end user.

In the case where the strip 22 is a layer of nonwoven material, the demolding of the hooks is carried out easily even with a nonwoven material whose grammage is less than 80 g/m² (mass of material in grams per square meter of nonwoven material). By way of example, the grammage of the nonwoven material can be included between 5 g/m² and 120 g/m², or between 25 g/m² and 100 g/m², or between 10 g/m² and 70 g/m².

In the case where the strip 22 is a layer of non-woven material, the equipment can include a calender device upstream of the substrate drive means 112, thus making it possible to carry out a step of calendaring, locally or not, the layer of non-woven material prior to its application against the base 12.

This mode of securing a strip 12 to a base 12 including retaining elements 16 is in particular advantageous in that it does not cause deformation of the base 12, and therefore advantageously allows retaining the shape of the base 12 obtained during the injection step, and in particular retaining the straight edges that can be obtained via the method and the equipment described previously.

This mode of securing a substrate to a tape can be applied to a method for forming a tape as described above, or more generally to any other method for forming a tape including retaining elements such as only hooks.

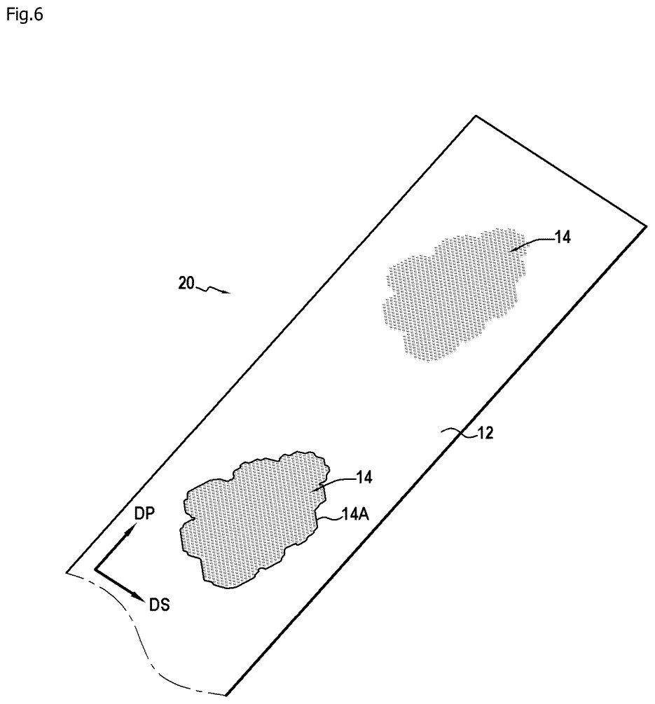

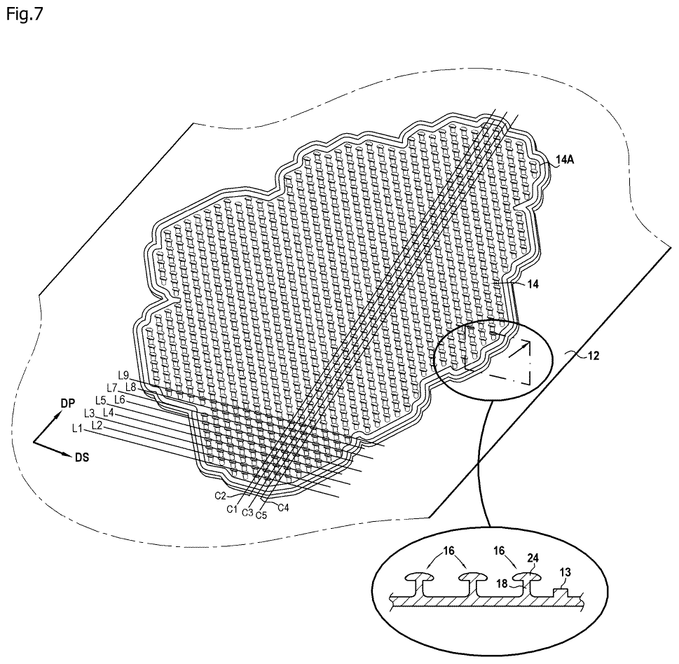

FIGS. 6 and 7 respectively show a view of a tape portion 26 obtained by means of the equipment 100 of FIG. 4, and a pattern 14 taken separately.

The tape portion 26 as presented has several disjoint patterns 14, each pattern 14 being formed of a plurality of retaining elements.

Each pattern 14 is surrounded by a region devoid of retaining elements, thus defining planar or substantially planar regions on the upper face 12A of the base 12.

The patterns 14 are formed by a succession of rows and columns of retaining elements, the columns and rows being arranged respectively along a primary direction DP and a secondary direction DS. The rows and columns are each formed of one or several retaining elements, if necessary aligned respectively along the secondary direction DS or the primary direction DP. A row of retaining elements typically includes between 1 and 1,000 retaining elements, more particularly between 2 and 500 retaining elements. A column of retaining elements typically includes between 1 and 1,000 retaining elements, more particularly between 2 and 750 retaining elements.

The base 12 typically has a constant width, the width of the base 12 being typically measured along the primary direction DP or the secondary direction DS.

The primary direction DP typically corresponds to the machine direction MD of the molding strip 102 described above, and the secondary direction DS typically corresponds to the transverse direction CD of the molding strip 102 described above.

The different rows and columns are typically evenly spaced according to a secondary interval and a primary interval respectively. The primary interval and the secondary interval can be equal or distinct. Alternatively, the rows are evenly spaced according to a first secondary interval and according to a second secondary interval, the second secondary interval not being an integer multiple of the first secondary interval and the first secondary interval being smaller than the second secondary interval, and/or the columns are evenly spaced according to a first primary interval and according to a second primary interval, the second primary interval not being an integer multiple of the first primary interval and the first primary interval being smaller than the second primary interval.

Each pattern 14 is typically surrounded by a region of the upper face of the base devoid of retaining elements, the region having a dimension strictly greater than twice the primary interval along the primary direction DP, and/or strictly greater than twice the secondary interval along the secondary direction DS.

The retaining elements 16 defining the rows and columns can be aligned or arranged in a staggered manner, which results in particular from the configuration of the cavities 102C of the molding strip 102 used for the production of the retaining device as already described above.

Each pattern 14 is typically surrounded by a region of the upper face 12A of the base 12 devoid of retaining elements, and is typically located at a distance at least equal to 1.5 mm, in some cases at least equal to 2.5 mm from a border of the upper face 12A of the base 12. By “border of the base 12” it is meant an end of the base 12, for example along the main direction DS or along the secondary direction DS.

### Different Rows and Columns of Retaining Elements Are Identified in FIG. 7.

This figure identifies the rows L1 to L9 which extend successively from one end of the pattern 12 along the primary direction DP, and the columns C1 to C5 which extend within the pattern 12.

The retaining elements 16 are counted on each of the rows L1 to L9 for a given pattern.

In the case of the pattern represented in FIG. 7, the rows have the following numbers of retaining elements: L1: 4, L2: 8, L3: 9, L4: 10, L5: 11, L6: 12; L7: 13, L8: 12, L9: 17.

In the same way, the retaining elements 16 are counted on each of the columns C1 to C5 for the pattern represented in FIG. 7: C1: 27, C2: 26, C3: 27, C4: 26, C5: 25.

The pattern 12 as proposed thus has at least two rows and/or two columns with distinct numbers of retaining elements. More generally, the pattern as proposed has at least X rows and/or X columns of retaining elements with distinct numbers of retaining elements, with X equal to 2, or even in some cases equal to 3 or 4 or 5, or more generally X is a natural number included between Xmin and Xmax, where Xmin can be for example equal to 2 or 3 or 4 or 5 or 6 or 7 or 8 or 9 or 10 or 12 or 15 or 20, and Xmax can for example be equal to 500 or 450 or 400 or 350 or 300 or 250 or 200 or 150 or 100 or 50.

The pattern thus formed can have different shapes, unlike the continuous and uniform patterns commonly produced for retaining elements.

Furthermore, for a given pattern, at least two rows and/or columns have distinct numbers of retaining elements, the difference between the numbers of retaining elements of the two rows or two columns being greater than or equal to 1, or more specifically greater than or equal to 2, or even greater than or equal to 3 or 4 or 5.

In the example represented in FIG. 7, considering the rows L1 to L9 and the columns C1 to C5, the represented pattern thus includes:
3 columns with distinct numbers of retaining elements, the difference between the numbers of retaining elements here being greater than or equal to 1 (columns C1, C2 and C5 for example).
2 columns with distinct numbers of retaining elements, the difference between the numbers of retaining elements here being equal to 2 (columns C1 and C5 for example).
8 rows with distinct numbers of retaining elements, the difference between the numbers of retaining elements here being greater than or equal to 1 (L1, L2 , L3, L4, L5, L6, L7, L9 for example).
2 rows having distinct numbers of retaining elements, the difference between the number of retaining elements here being equal to 4 (L1 and L2 for example, or L2 and L8).

In addition, for each pair of rows or columns arranged successively, the variation in the number of retaining elements between the rows or columns of the pair is typically less than or equal to 10, or less than or equal to 15.

More generally, for each pair of rows or pair of columns arranged successively, the variation in the number of retaining elements between the rows or columns of the pair is typically less than or equal to 40%, 30% or 15% of the maximum number of retaining elements for the rows of the pattern. For each pair of columns arranged successively, the variation in the number of retaining elements between the rows or columns of the pair is typically less than or equal to 40%, 30% or 15% of the maximum number of retaining elements for the columns of the pattern. Such characteristics allow modulating the force necessary for the disengagement of the retaining device when the retaining elements are engaged with complementary elements such as retaining elements or a nonwoven material. Such a product is also easier to produce, in particular easier to demold from the molding device.

Furthermore, in the embodiment represented in FIG. 7, the pattern 12 is bordered by a rib 13 here forming a continuous contour around the pattern 14a. In the example illustrated, the rib 13 has a rectangular section. It is however understood that a rib 13 bordering the pattern 14a can have any section, and can be continuous or discontinuous.

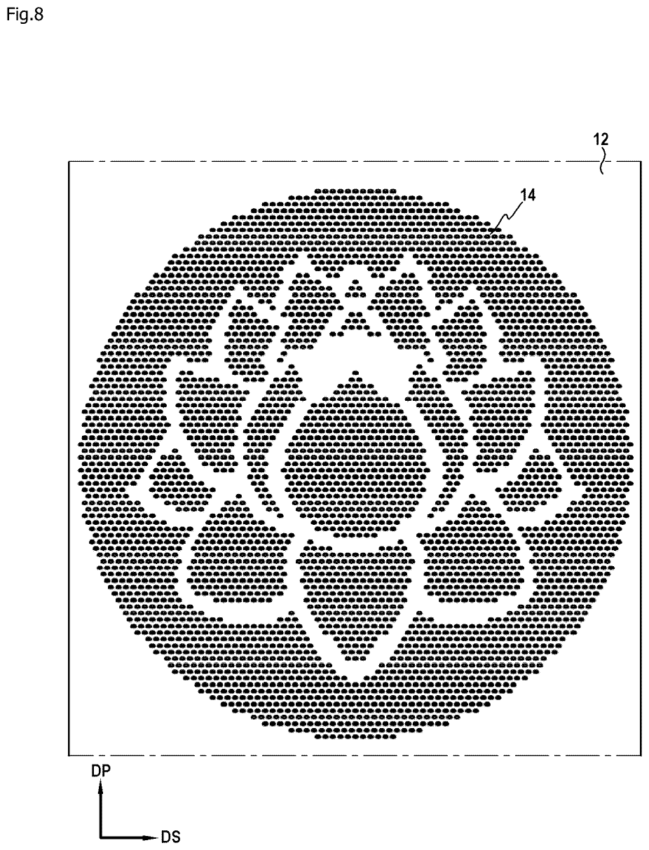

FIGS. 8 to 11 show other examples of patterns that can be formed by the retaining elements and therefore by the cavities used for forming the retaining elements.

These figures indicate the primary direction DP and the secondary direction DS.

The different relationships between the numbers of retaining elements or cavities for the different rows and columns of the pattern already described with reference to FIG. 7 also apply for the patterns represented in FIGS. 8 to 11.

The different patterns presented here are inscribed in an outer contour, here a circle, having for example a diameter on the order of 24 mm, or more generally included between 10 mm and 45 mm. The patterns here are formed by areas devoid of retaining elements within the outer contour. It is understood that the geometry of the outer contour may vary, and is not limited to a circle.

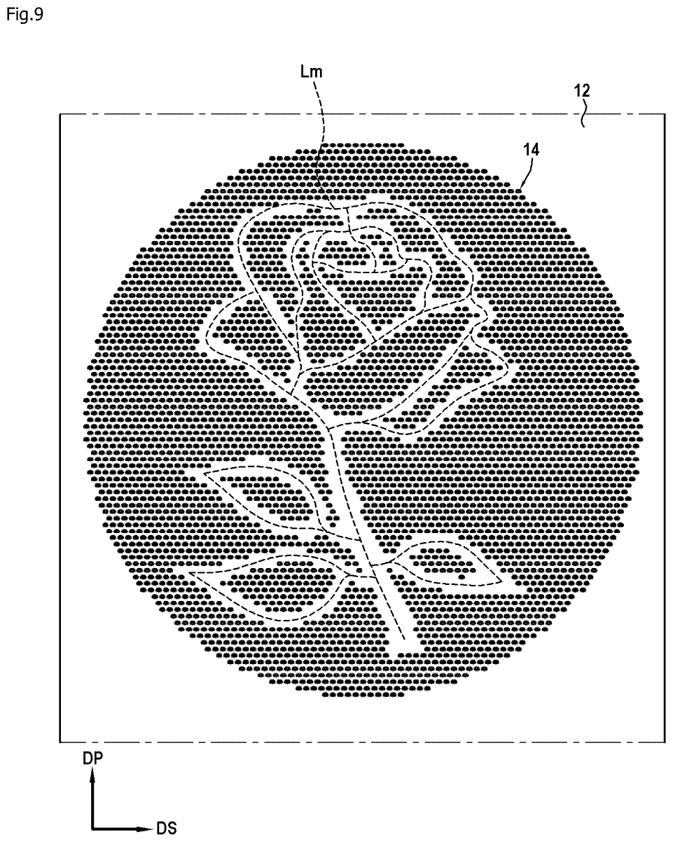

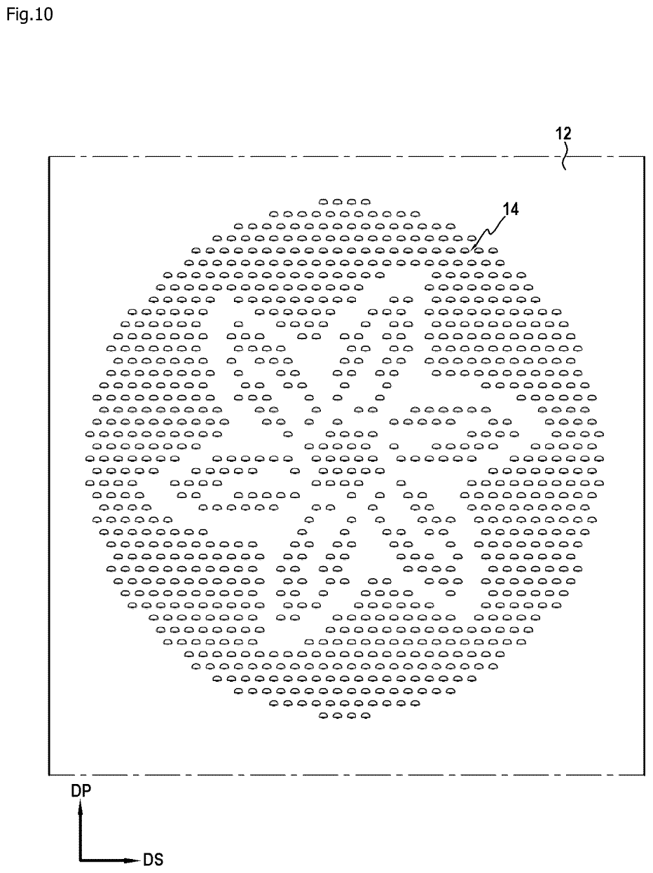

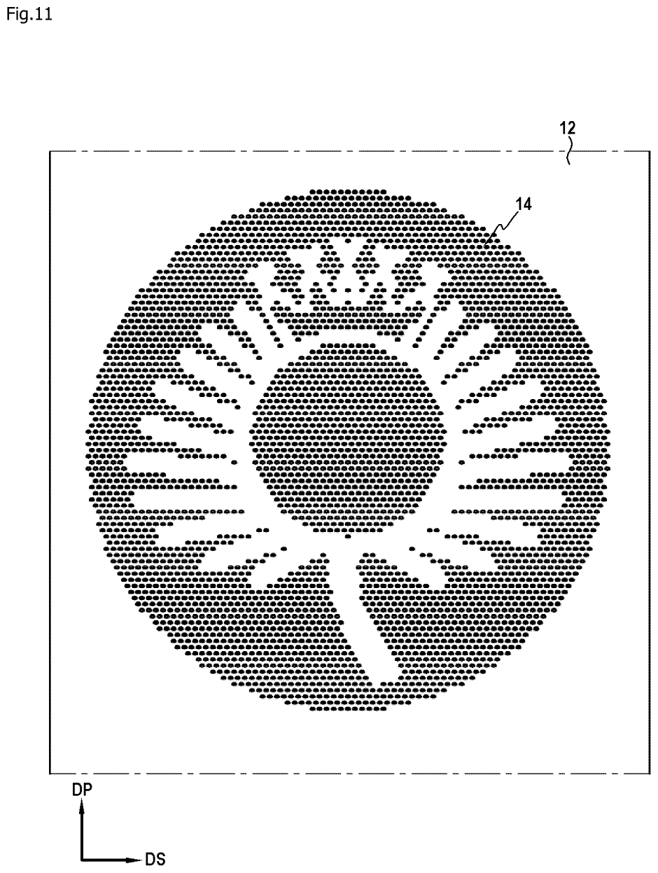

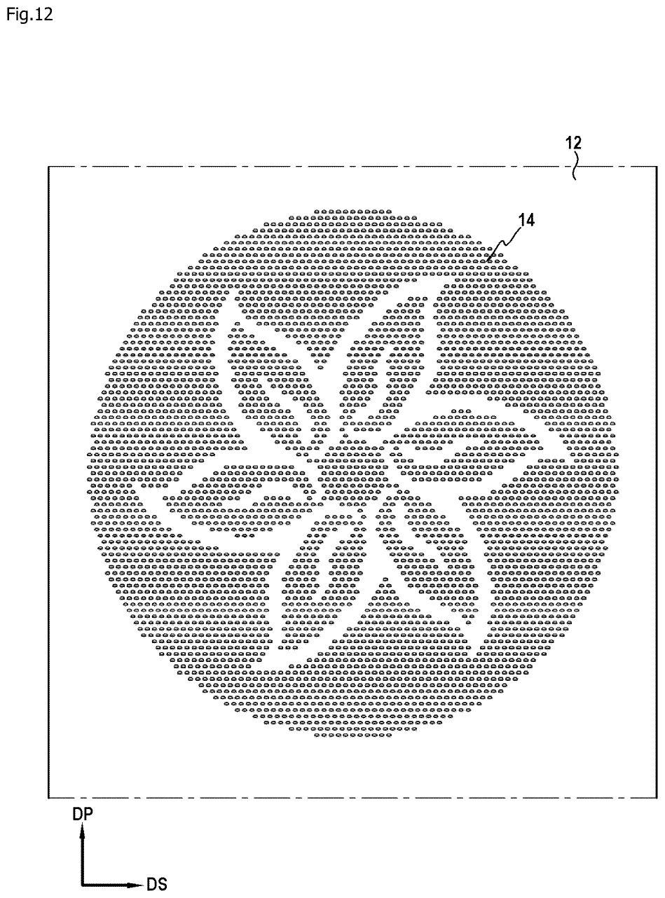

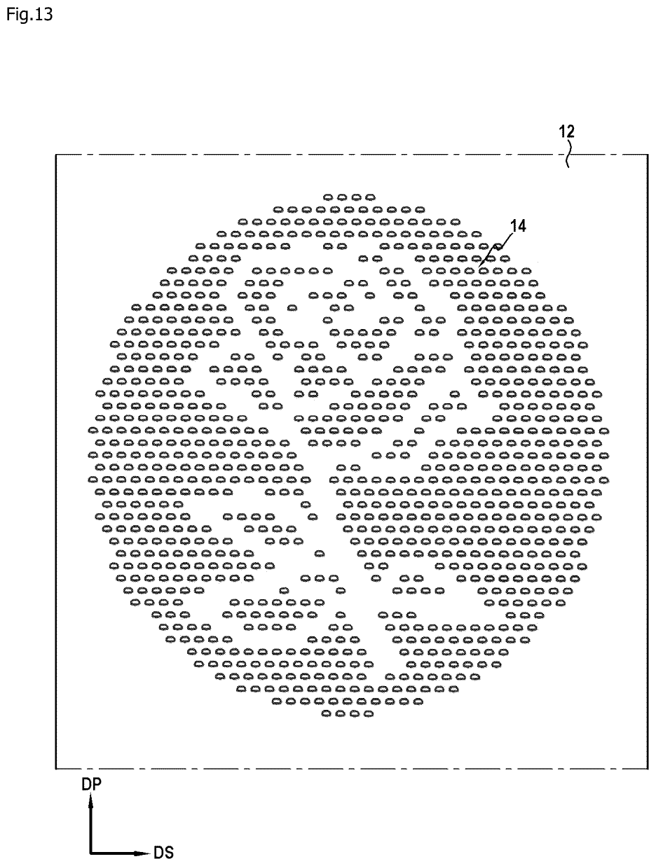

In the case of the pattern represented in FIG. 8, the areas devoid of retaining elements define a pattern of the lotus flower type. In the case of the pattern represented in FIG. 9, the areas devoid of retaining elements define a pattern representing a rose. In the case of the pattern represented in FIG. 10, the areas devoid of retaining elements define a pattern representing a flower. In the case of the pattern represented in FIG. 11, the areas devoid of retaining elements define a pattern representing a burdock flower. FIG. 12 is a variant of FIG. 10. FIG. 13 is a variant of FIG. 9.

As seen in these figures, the density of the retaining elements (or cavities) can vary. FIGS. 8, 9, 11 and 12 thus show patterns produced with a density of retaining elements (or cavities) on the order of 1,093 retaining elements (or cavities)/cm², while FIGS. 10 and 13 present patterns produced with a density of retaining elements (or cavities) on the order of 273 retaining elements (or cavities)/cm².

As can be seen in these FIGS. 8 to 13, for each pattern, at least one row and/or at least one column includes at least two groups of disjoint retaining elements (or cavities), separated by an area devoid of retaining elements or cavities.

By “area devoid of retaining elements or cavities” it is meant an area in which, by complying with the pitch of the retaining elements or of the cavities, a retaining element or a cavity would normally have been present.

Considering that the rows and columns of retaining elements are evenly spaced according to a secondary interval and a primary interval respectively, the at least one area devoid of retaining elements included in the area delimited by the outer contour of each pattern has a dimension along the primary direction DP strictly greater than twice the primary interval, and a dimension along the secondary direction DS strictly greater than twice the secondary interval.

In the same way, considering that the rows and columns of cavities are evenly spaced according to a transverse interval and a machine interval respectively, the at least one area devoid of retaining elements included in the area delimited by the outer contour of each pattern has a dimension along the machine direction MD strictly greater than twice the machine interval, and a dimension along the transverse direction CD strictly greater than twice the transverse interval.

According to one example, for each pattern, the ratio between the surface of the areas devoid of retaining elements (or cavities) contained in the outer contour and the surface including retaining elements (or cavities) is less than 1. The surface of the pattern is defined as being the surface covered by circles with a radius corresponding to the average pitch and whose the center is positioned respectively, in top view, on the center of the retaining elements (or cavities) and the circumference of each circle passes through the center of at least one adjacent retaining element (or cavity). The average pitch can correspond to the distance separating two adjacent retaining elements (or cavities). The at least one area devoid of retaining elements is the surface not covered by the pattern surface.

According to one example, for each pattern, at least one, or for example each, area devoid of retaining elements (or cavities) included in the pattern has a width and a length, so that the ratio between the length and the width is strictly greater than 1.2, particularly strictly greater than 1.5.

According to one example, the (or each) pattern being delimited by an outer contour, and the (or each) pattern including, in the area delimited by its outer contour, at least one area devoid of retaining elements (or cavities), the inner contour has at least one local portion of elongated shape defining a local center line arranged at a distance from the local inner contour less than 20%, particularly less than 15%, of the dimension of the pattern along the primary direction and/or the secondary direction, or alternatively or additionally at a distance from the local inner contour of less than 10 mm, or less than 5 mm, particularly less than 3 mm, more particularly less than 2 mm, more particularly less than 1 mm and greater (or strictly greater) than an average pitch of the retaining elements in the considered pattern. Such a center line Lm is represented in FIG. 9. A circular area devoid of retaining elements does not have a median within the meaning of the present document. Thus, the retaining device has a maximized grip while allowing a more detailed and accurate representation of the pattern. The local center line includes straight and/or curved portions. The length of the center line of the at least one inner contour is typically greater than 10 mm, or for example greater than 12 mm. The sum of the lengths of the center lines of the inner contours of a pattern is typically greater than 12 mm, for example greater than 15 mm and/or typically less than 600 mm, for example less than 400 mm, more particularly less than 200 mm.

In addition to or independently of the various characteristics described above, the retaining elements 16 can be made so as to each have a rod extending from the base 12, and a head extending from the end of the rod opposite to the base. The retaining elements 16 are then typically produced such that for a given pattern 14, the dimension of the head of the retaining elements of the pattern decreases between a first end of the pattern and a second end of the pattern.

More specifically, considering a given pattern, typically for each pattern of a tape, a first direction of the pattern is defined, which can for example be the main direction DP or the secondary direction DS, and the retaining elements 16 forming a first end of the pattern and a second end of the pattern along the first direction are determined. The retaining elements 16 each have a head with a maximum dimension measured along a second direction. The retaining elements 16 forming the first end of the pattern have a head with a first maximum dimension. The retaining elements forming the second end of the pattern have a head with a second maximum dimension. The second maximum dimension is strictly smaller than the first maximum dimension. The retaining elements 16 forming the first end and the retaining elements 16 forming a second end are arranged on the same column or row. The first direction is the direction MD. The first direction being the direction MD, the direction from the first end to the second end is the direction MD.

According to one embodiment, the maximum dimension of the head of the retaining elements is decreasing, typically strictly decreasing from the first end to the second end of the pattern.

According to one example, the ratio of the second maximum dimension on the first maximum dimension is included between 1.01 and 1.60, particularly between 1.01 and 1.35, more particularly between 1.02 and 1, 15, in some cases between 1.03 and 1.12.

Such a variation in the maximum dimension of the heads of the retaining elements allows modulating the force required to disengage the retaining elements by considering a peel force from a first end of the pattern to a second end of the pattern.

The retaining device typically has a 180° peel force which is strictly greater than 0.02 N, in some cases strictly greater than 0.1 N along the primary direction DP and/or along the secondary direction DS.

The “180° Peel” method is a method that allows measuring the peel force, i.e. the force to separate an assembly (here the retaining device) and an application area. This method is described below.

Conditioning of the samples—The samples to be tested are conditioned for 2 h (hour) at 23° C.+/−2° C. with a relative humidity of 50%+/−5%.

Preparation of the retaining device—The retaining device is generally in the form of a tape whose length is in the primary direction DP or the secondary direction DS. Part of the tape along the primary direction DP or the secondary direction DS is bonded on an 80 g/cm² paper and a 2 kg (kilogram) roller is applied or rotated on the retaining device in one direction and then in the other (back and forth) over the entire length of the tape part. The paper and the retaining device are cut with a cutting tool into 25.4 mm (millimeter) wide bands in the primary direction DP or secondary direction DS at a rate of about 700 mm/min (millimeter per minute). Each band of paper has a length of 210 mm and the anti-slip strip is disposed in the center of this band.

Preparation of the application area—The sample of the application area has, for example depending on the size of the retaining device, a width of 50 mm in the primary direction DP or the secondary direction DS and the length is a maximum of 200 mm and the sample is cut in half depending on the length.

Assembly—The band is disposed over the sample of the application area so that the retaining device is centered on the sample of the application area. The 2 kg (kilogram) roller is applied or rotated over the band in one direction and then in the other (back and forth) over the entire length of the band at a rate of about 700 mm/min. The sample from the application area is disposed in a clamp of a gallows, the cut side being in the clamp and a 1 kg weight is suspended from the lower part of the band for 10 s (second). The weight is then removed. This step ensures the assembly of the retaining device and of the sample from the application area.

Measurement—The assembly is then disposed in a tensile testing machine including a 100 N (Newton) measuring cell. The band is inserted into the upper (movable) jaw. The force measuring cell reading is set to zero. The sample of the application area is inserted into the lower (fixed) jaw and a slight tension is created. The force should be included between 0.02 N and 0.05 N. During the installation, the jaws are separated apart from each other by 50 mm. The assembly is centered between the two jaws. The test is carried out at constant displacement at a rate of 305 mm/min and the test run is of 50 mm. This test run is adapted according to the width of the retaining device to be tested.

In order to produce a tape 26 provided with such retaining elements 16, it is understood that the molding strip 102 used for the equipment 100 has cavities 102C with a configuration similar to that of the retaining elements.

Thus, it is understood that to form a given pattern of retaining elements, the molding strip 102 used has functional cavities 102C disposed in a similar pattern. Non-functional cavities will be assimilated here to an absence of cavities.

More generally, the molding strip 102 having a plurality of cavities 102C arranged in rows and columns extending respectively along the transverse direction CD and the machine direction MD, the cavities 102C opening out onto the outer face of the molding strip 102.

A row of cavities typically includes between 1 and 1,000 cavities. A column of cavities typically includes between 1 and 1,000 cavities.

The cavities 102C are arranged to form patterns, typically disjoint patterns, on the outer face of the molding strip 102. Each pattern is formed by a plurality of rows and columns of cavities 102C.

The different patterns are typically disjointed.

The molding strip can have one or several patterns, which can be repeated on the molding strip.

The different rows and columns are typically evenly spaced according to a transverse interval and a machine interval respectively. The transverse interval and the machine interval may be equal or distinct. According to another example, the rows are evenly spaced according to a first transverse interval and according to a second transverse interval, the second transverse interval not being an integer multiple of the first transverse interval and the first transverse interval being smaller than the second transverse interval, and/or the columns are evenly spaced according to a first machine interval and according to a second machine interval, the second machine interval not being an integer multiple of the first machine interval and the first machine interval being smaller than the second machine interval.

Each pattern is typically surrounded by a region of the outer face of the molding strip devoid of retaining elements, the region having a dimension strictly greater than twice the machine interval along the machine direction MD, and/or strictly greater than twice the transverse interval along the transverse direction CD.

The cavities 102C defining the rows and columns can be aligned or arranged in a staggered manner.

Each pattern is typically surrounded by a region of the outer face of the molding strip devoid of cavities, and is typically located at a distance at least equal to 1.5 mm, in some cases at least equal to 2, 5 mm from a border of the outer face of the molding strip. By “border of the molding strip” it is meant an end of the molding strip, for example along the machine direction MD or along the transverse direction CD.

As for the retaining elements, the patterns formed by the cavities thus have at least two rows and/or two columns with distinct numbers of cavities. More generally, the pattern as proposed presents at least Y rows and/or Y columns of cavities with distinct numbers of cavities, with Y equal to 2, or in some cases equal to 3 or 4 or 5 or more generally Y is a natural number included between Ymin and Ymax, where Ymin can be for example equal to 2 or 3 or 4 or 5 or 6 or 7 or 8 or 9 or 10 or 12 or 15 or 20, and Ymax can for example be equal to 500 or 450 or 400 or 350 or 300 or 250 or 200 or 150 or 100 or 50.

Furthermore, for a given pattern, at least two rows and/or columns have distinct numbers of cavities, the difference between the numbers of cavities of the two rows or two columns being greater than or equal to 1, or more specifically greater than or equal to 2, or greater than or equal to 3 or 4 or 5.

In addition, for each pair of rows or columns arranged successively, the variation in the number of cavities between the rows or columns of the pair is typically less than or equal to 10, or even less than or equal to 15.

More generally, for each pair of rows arranged successively, the variation in the number of cavities between the rows or columns of the pair is typically less than or equal to 40%, 30% or 15% of the maximum number of cavities for the rows of the pattern. For each pair of columns arranged successively, the variation in the number of cavities between the rows or columns of the pair is typically less than or equal to 40%, 30% or 15% of the maximum number of cavities for the columns of the pattern.

Alternatively, the pattern could have other shapes, for example other flower shapes, such as a daisy, a thistle or a cotton flower or for example an animal, a logo, a word or a “QR code”.

Alternatively to FIGS. 6 to 13, the pattern could be oriented differently, for example at an angle of 90 degrees.

Although the present disclosure has been described with reference to specific exemplary embodiments, it is obvious that modifications and changes can be made to these examples without departing from the general scope of the disclosure as defined by the claims. Particularly, individual characteristics of the different illustrated/mentioned embodiments can be combined in additional embodiments. Accordingly, the description and the drawings should be considered in an illustrative rather than restrictive sense.

It is also clear that all the characteristics described with reference to one method can be transposed, alone or in combination, to one device, and conversely, all the characteristics described with reference to one device can be transposed, alone or in combination, to one method.

1. A molding device configured to form a retaining device comprising a base provided with one or more of a plurality of retaining elements and preforms of retaining elements, the molding device comprising:
a molding strip formed of a first material and adapted to be mounted on a support, the molding strip extending along a machine direction, having a width defined along a transverse direction perpendicular to the machine direction, and a thickness measured along a direction perpendicular to the machine direction and to the transverse direction, the molding strip having an inner face and an outer face, and the molding strip comprising a plurality of cavities, wherein part of the cavities are at least partially obturated with a plugging material, so as to define among the plurality of cavities:
molding cavities configured to form one or more of a plurality of retaining elements and preforms of retaining elements, and
non-functional cavities,
wherein the plugging material is at least partly arranged in cavities among the plurality of cavities to define the non-functional cavities, the plugging material arranged between the inner face and the outer face of the molding strip has a shape complementary to at least a part of an internal volume of the cavity within which the plugging material is arranged, and
wherein the first material is a metal material or a composite thereof.

2. The device according to claim 1, wherein the plugging material is distinct from the first material of the molding strip.

3. The device according to claim 1, wherein the plugging material is at least one of a resin and/or a sealant.

4. The device according to claim 1, wherein the plugging material extends on one or more of the inner face and the outer face of the molding strip.

5. The device according to claim 1, wherein the non-functional cavities are totally obturated by the plugging material.

6. The device according to claim 4, wherein the plugging material is at least one of a resin or a sealant.

7. The device according to claim 1, wherein the molding cavities are arranged to form a pattern on the molding strip.

8. The device according to claim 1, wherein the molding strip has a thickness comprised between 50 and 500 microns.

9. The device according to claim 1, wherein among the cavities, between 10% and 90% of the total number of cavities of the molding strip are at least partially obturated by the plugging material.

10. The device according to claim 1, wherein the molding strip has a perimeter comprised between 200 mm and 3,000 mm.

11. The device according to claim 1, wherein the molding strip has a density of cavities comprised between 50 and 3,000 per cm².

12. The device according to claim 1, wherein the molding strip has borders extending along its ends along the machine direction, and wherein the cavities located at a distance, along the transverse direction comprised between 2 and 5 mm from the borders, are obturated.
